(19) United States
(12) Patent Application Publication
(10) Pub. No.: US 2025/0189394 A1
(43) Pub. Date: Jun. 12, 2025

(54) VACUUM PRESSURE SENSOR COMPRISING A CONTAMINATION SHIELD

(71) Applicant: Setra Systems, Inc., Boxborough, MA (US)

(72) Inventor: Gino A. PINTO, Milford, MA (US)

(21) Appl. No.: 18/970,516

(22) Filed: Dec. 5, 2024

Related U.S. Application Data
(60) Provisional application No. 63/607,399, filed on Dec. 7, 2023.

(51) Int. Cl. G01L 9/00; G01L 19/06

(52) U.S. Cl. CPC G01L 9/0072; G01L 19/0627

(57) ABSTRACT

A vacuum pressure sensor comprises an electrode and a diaphragm forming a capacitive structure. The sensor further comprises a housing defining a sensor cavity and comprising a support structure configured to support the capacitive structure within the sensor cavity. The diaphragm resides in a diaphragm plane and the electrode extends substantially parallel to the diaphragm on a first side of the diaphragm plane. The housing further comprises an inlet disposed on a second side of the diaphragm plane and configured to be in fluid communication with a measured environment. The sensor further comprises a contamination shield, disposed in the sensor cavity between the inlet and the capacitive structure, wherein the contamination shield is configured to provide at least one fluid communication path from the inlet to the diaphragm, and wherein each of the at least one fluid communication path crosses the diaphragm plane at least twice.

### FIELD

The present disclosure relates generally to vacuum pressure sensors and, in particular, to a vacuum pressure sensor comprising a contamination shield.

### BACKGROUND

Industrial systems and processes used to deposit and remove materials from a base substrate, e.g., semiconductor fabrication processes, often require vacuum chambers with tightly controlled environments for supplying required reactive gases at controlled concentrations, pressures, temperatures and flowrates. Examples of such applications and processes include various types of deposition and etching processes, as well as sterilization processes.

In these industrial systems, sensors are needed to measure process parameters including pressure, temperature, and gas flowrate. For instance, capacitance diaphragm gauges are known in the art, simplified examples of which are illustrated in FIGS. 1 and 2. With reference to FIG. 1, a vacuum pressure sensor 100 comprises a housing 102 defining a sensor cavity 104, which cavity has a capacitive structure 108 disposed therein. A conduit forms an inlet 106 and is connected to the housing 102 in an airtight fashion and provides fluid communication for media, as depicted by the heavy arrows, from a measured environment (e.g., a vacuum chamber, not shown) to the sensor cavity 104. The capacitive structure 108 comprises a conductive, flexible diaphragm 108 supported at a fixed distance from an electrode 110 residing in a permanently sealed vacuum environment 112, thereby forming a capacitor. In a nominal state (i.e., undeflected), the diaphragm 108 lies within a plane 114 that bisects the sensor cavity 104 such that the capacitive structure 108 has a known capacitance value. As the diaphragm 108 is exposed to varying pressures from the measured environment, the diaphragm 108 deflects to varying degrees, thereby changing the capacitance of the capacitive structure. Using known components and circuitry, such changes in capacitance may be measured such that pressure in the measured environment may be determined.

The noted industrial systems often generate byproducts of reaction such as vapors and particulates that migrate to a sensor's cavity are deployed and contaminate and/or corrode sensing elements disposed therein. These contaminants are often in the form of deposited films and particulates that deposit on the sensing element such as the sensing diaphragm 108 of a capacitive sensor. If such process contamination is allowed to accumulate on or corrode a sensor's sensing element, measurement accuracy and sensor output stability will degrade over time. Preventing process contamination of such sensing elements is important to ensure proper performance and reliability of sensor's measurement output, and various techniques for minimizing such contamination are known in the art.

For example, heated vacuum manometers are often used in which temperature of the sensor is controlled to be high enough to prevent vapor condensation in the sensor cavity. While this method is highly effective preventing contamination from condensation, such heated manometers are more expensive than non-heated manometers and do not prevent particle contamination from entering and affecting the sensor element.

As another example, discrete in-line filters have been utilized to trap particulate contamination in the conduits leading to sensors. However, such filters involve extra system components and may not be effective in condensing vapors before they reach the sensor's sensing element.

Further still, routine maintenance has been employed to remove contaminants within the sensor's sensing cavity through rinsing with solvents. However, this technique requires a system shut down to perform the maintenance and its effectiveness is highly dependent on the specific solvent used as well as the technique utilized to conduct such rinsing. Sensor damage or degradation may also result if inadequate or inappropriate solvent is used, or improper rinsing technique is employed.

The use of a shield barrier or plasma shield is a common technique for protecting the sensing diaphragm from direct exposure to process contaminants, examples of which are illustrated in FIGS. 1 and 2. In FIG. 1, a disc-like shield 120 is deployed within the sensor cavity 104 and configured such that it prevents line-of-sight communication of incoming fluid media from the conduit 106 to the diaphragm. Similarly, in FIG. 2, the sensor 200 (which includes essentially the same housing, conduit and sensing structure as shown in FIG. 1) includes a helical shield 220 deployed within the input conduit and that, once again, prevents line-of-sight access from the measured environment to the sensor cavity. Although such shields 120, 220 provide a form of protection as a primary barrier impeding most contaminants, they still leave significant paths around such shields that lead to secondary contamination exposure of sensitive diaphragm areas.

Thus, techniques that overcome the above-noted shortcomings of prior art techniques would be a welcome addition to the art.

### SUMMARY

The above-described shortcomings are addressed through the provision of a vacuum pressure sensor in accordance with the instant disclosure. In an embodiment, such a sensor comprises an electrode and a diaphragm forming a capacitive structure. The sensor further comprises a housing defining a sensor cavity and comprising a support structure configured to support the capacitive structure within the sensor cavity. The diaphragm resides in a diaphragm plane and the electrode extends substantially parallel to the diaphragm on a first side of the diaphragm plane. The housing further comprises an inlet disposed on a second side of the diaphragm plane and configured to be in fluid communication with a measured environment. The sensor further comprises a contamination shield, disposed in the sensor cavity between the inlet and the capacitive structure, wherein the contamination shield is configured to provide at least one fluid communication path from the inlet to the diaphragm, and wherein each of the at least one fluid communication path crosses the diaphragm plane at least twice.

In an embodiment, the housing and contamination shield are formed from corrosion resistant material, such as INCONEL or 316L stainless steel.

In an embodiment, the contamination shield is mounted on the support structure.

In an embodiment, each of the at least one fluid communication path is provided in part by an aperture formed in the contamination shield on the first side of the diaphragm plane.

In an embodiment, the contamination shield comprises a lower wall extending substantially parallel to, and on the second side of, the diaphragm plane, and further comprises a lateral wall extending from the lower wall such that a distal edge of the lateral wall terminates on the first side of the diaphragm plane.

In an embodiment, the support structure comprises an undercut region extending substantially parallel to, and on the first side of, the diaphragm plane to define a backside surface of the support structure. Further to this embodiment, the contamination shield may comprise a lower wall extending substantially parallel to, and on the second side of, the diaphragm plane, a lateral wall extending from the lower wall to the first side of the diaphragm plane and an upper wall extending from the lateral wall substantially parallel to the diaphragm plane, wherein the upper wall is disposed between the housing and the backside surface of the support structure, and wherein the upper wall comprises at least one aperture defining the at least one fluid communication path. Still further to this embodiment, the contamination sensor may be formed from an upper shield section and a lower shield section, wherein the upper shield section is provided as a portion of the support structure or wherein the upper shield section comprises the upper wall. Additionally, the upper shield section my comprise at least a portion of the lateral wall.

In an embodiment, a fluid communication path of the at least one fluid communication path comprises at least one labyrinth feature partially obstructing the fluid communication path. The at least one labyrinth feature may be disposed on the housing and/or the contamination shield.

### BRIEF DESCRIPTION OF THE DRAWINGS

The foregoing and other features and advantages will be discussed in detail in the following non-limiting description of specific embodiments in connection with the accompanying drawings, in which:

FIG. 1 a schematic cross-sectional view illustrating a first embodiment of a vacuum pressure sensor comprising a contamination shield in accordance with prior art techniques;

FIG. 2 is a schematic cross-sectional view illustrating a second embodiment of a vacuum pressure sensor comprising a contamination shield in accordance with prior art techniques;

FIG. 3 is a schematic cross-sectional view illustrating a first embodiment of a vacuum pressure sensor comprising a contamination shield in accordance with the instant disclosure;

FIG. 4 is a schematic cross-sectional view illustrating a second embodiment of a vacuum pressure sensor comprising a contamination shield in accordance with the instant disclosure;

FIG. 5 is a schematic cross-sectional view illustrating a third embodiment of a vacuum pressure sensor comprising a contamination shield in accordance with the instant disclosure; and

FIG. 6 is a schematic cross-sectional view illustrating a fourth embodiment of a vacuum pressure sensor comprising a contamination shield in accordance with the instant disclosure.

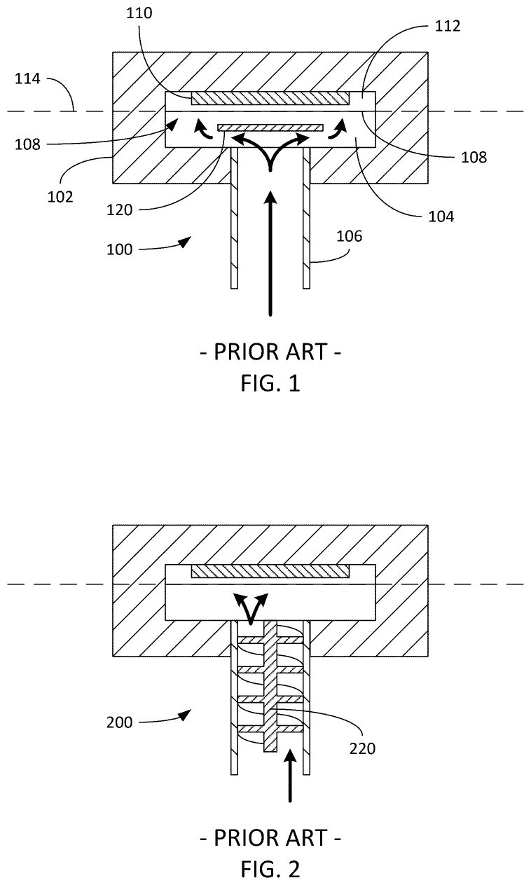

### DETAILED DESCRIPTION OF THE PRESENT EMBODIMENTS

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied by context otherwise.

As used herein, the phrase “operatively connected” refers to at least a functional relationship between two elements and may encompass configurations in which the two elements are directed connected to each other, i.e., without any intervening elements, or indirectly connected to each other, i.e., with intervening elements.

As used herein, the phrase “fluid communication” refers to a configuration between two or more elements in which fluid is able to flow in at least one direction between such elements.

All of the vacuum pressure sensors illustrated in the accompanying Figures are not drawn to scale. Furthermore, as known in the art, the various sensors illustrated in the Figures are generally cylindrical in shape about a longitudinal axis.

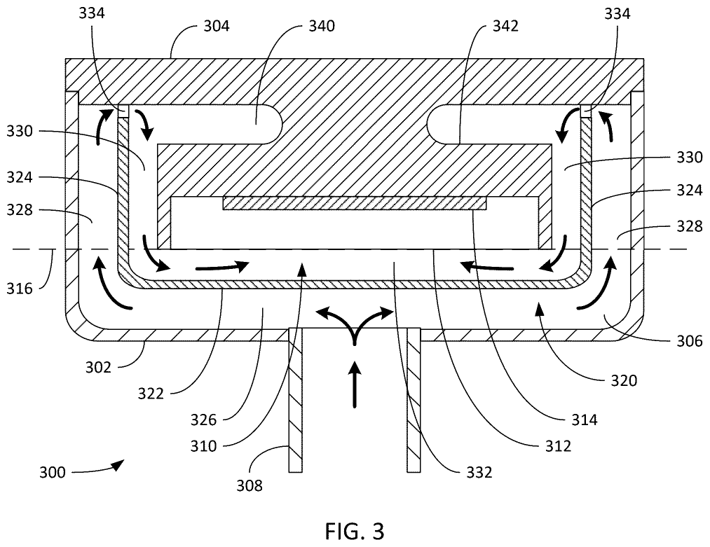

Referring now to FIG. 3, a simplified illustration of a first embodiment of a vacuum pressure sensor 300, comprising a contamination shield in accordance with the instant disclosure, is shown. The sensor 300 comprises a housing 302 mounted on a support structure 304 such that an airtight sensor cavity 306 is formed therebetween. The materials used for the housing 302 and mounting structure 304 are in keeping with those typically used in the art. A conduit, having an airtight connection to the housing 302, forms a fluid inlet 308 to the sensor cavity 306. In accordance with known techniques, the support structure 304 is configured to support a capacitive structure 310, comprising a diaphragm 312 and electrode 314, within the sensor cavity 306. In a nominal, undeflected state, the diaphragm 312 lies within a diaphragm plane 316. Throughout the instant disclosure, areas above diaphragm planes as depicted in the instant Figures are deemed a first side of the diaphragm plane, whereas areas below diaphragm planes as depicted in the instant Figures are deemed a second side of the diaphragm plane.

Once again, it is noted that the structures illustrated in FIG. 3 are not drawn to scale; for example, for a diaphragm 312 having a diameter of 1 inch (25.4 mm), spacing between the diaphragm 312 and electrode 314 will be about 0.005 inches (0.13 mm). Components and circuitry providing electrical communication with the diaphragm 312 and electrode 314 are well-known in the art and are not shown in FIG. 3 for ease of illustration.

The sensor 300 further comprises a contamination shield 320 disposed within the sensor cavity 306 between the inlet 308 and the capacitive structure 310 such that line-of-sight communication, as well as fluid communication between the inlet 308 and the capacitive structure 310 is obstructed. The contamination shield 320 is configured to provide at least one fluid communication path from the inlet 308 to the diaphragm 312 while simultaneously ensuring that the at least one fluid communication path is circuitous, thereby reducing the likelihood of contaminants reaching the diaphragm 312. In the context of the instant disclosure, the term “circuitous” means that a contamination shield in accordance with all embodiments of the instant disclosure is configured to ensure that the at least one fluid communication path provided thereby crosses the diaphragm plane at least twice, as described in further detail below. Such a configuration will tend to substantially surround or isolate the capacitive structure 310 from the inlet 308, thereby making it more difficult for contaminants to reach the capacitive structure 310, while still providing a relatively compact structure for the sensor 300. Such a configuration also has the further benefit of isolating the capacitive structure 310 from environmental factors (e.g., barometric pressure, thermal transients, etc.), thereby improving accuracy and consistency of the sensor 300. Various examples of contamination shields meeting these criteria are illustrated in the various embodiments described herein.

Generally, contamination shields in accordance with the instant disclosure are preferably fabricated from corrosion resistant materials (particularly, materials that are resistant to the specific industrial process chemicals and contaminants to which it is likely to be exposed). Examples of such materials include “INCONEL” alloy or 316L stainless steel. Still other materials suitable for this purpose will be apparent to those skilled in the art.

In the first embodiment of FIG. 3, the contamination shield 320 is formed as a cup-like structure having a lower or bottom wall 322 and an annular lateral wall 324 extending substantially perpendicularly from a periphery of the lower wall 322. A diameter of the contamination shield 320 is such that it is larger than an outer diameter of the capacitive structure 310 but smaller than an inner diameter of the housing 302, thereby forming flow paths as described in further detail below. As shown in FIG. 3, the contamination shield 320 is mounted on the support structure 304 using known techniques (e.g., welding), though this is not a requirement, i.e., in an alternative embodiment, the contamination shield 320 could be mounted on the housing 302 via, for example, suitable support struts or the like. In the illustrated embodiment, the lower and lateral walls 322, 324 are integrally formed as a single unit. As further shown, the lower wall 322 is configured to extend substantially parallel relative to the diaphragm plane 316. A feature of the contamination shield 320 is that the lower wall 322 is deployed on the second (lower) side of the diaphragm plane 316, whereas the lateral wall 324 extends from the lower wall 322, across the diaphragm plane 316 and has a distal edge (relative to the lower wall 322) that terminates at a point on the first side of the diaphragm plane 316. In this manner, the configuration, placement and sizing of the contamination shield 320 relative to the configuration, placement and sizing of the housing 302 and capacitive structure 310 results in the establishment of fluid communication paths that are forced to cross the diaphragm plane 316 at least twice.

In conjunction with the housing 302, the bottom and lateral walls 322, 324 form a first horizontal flow path 326 and a first (annular) vertical flow path 328. In a similar manner, and in conjunction with the support structure 304 and capacitive structure 310, the bottom and lateral walls 322, 324 also form a second (annular) vertical flow path 330 and a second horizontal flow path 332. In the illustrated embodiment, the lateral wall 324 comprises at least one aperture 334 providing fluid communication, albeit restricted, between the respective vertical flow paths 328, 330. In this manner, fluid communication between the horizontal flow paths 326, 332, vertical flow paths 328, 330 and at least one aperture 334 give rise to at least one fluid communication path from the inlet 308 to the diaphragm 312. As shown by the heavy arrows, media from the measured environment is thus able to flow through the inlet 308, into the first horizontal flow path 326 and thereafter into the first vertical flow path 328, thereby traversing the diaphragm plane 316 a first time. The media is able to continue to flow through the apertures 334, into the second vertical flow path 330 and into the second horizontal flow path 332, thereby traversing the diaphragm plane 316 a second time. Media present in the second horizontal flow path 332 impinges upon the diaphragm 312 thereby permitting measurement of pressure within the measured environment. Formed in this manner, the at least one fluid communication path from the inlet 308 to the diaphragm 312 establishes a relatively lengthy path and surfaces that provide greater opportunity for particulates and condensates to accumulate before encountering the diaphragm 312.

As further depicted in FIG. 3, the support structure 304 may optionally have an undercut region 340 formed therein such that that the undercut region 340 extends behind the capacitive structure 310 and gives rise to a backside surface 342 of the capacitive structure 310. Techniques for forming such an undercut region are known to those skilled in the art. The presence of the undercut region 340 may provide additional surface area where particulates or condensates can come to rest prior to encountering the diaphragm 312. Furthermore, in additional embodiments described below, the undercut region 340 may be configured to receive a portion of the contamination shield.

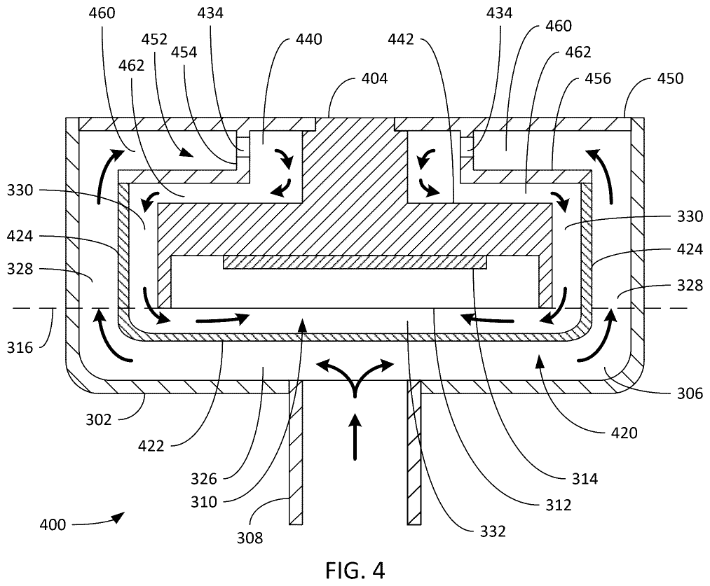

Referring now to FIG. 4, a simplified illustration of a second embodiment of a vacuum pressure sensor 400, comprising a contamination shield in accordance with the instant disclosure, is shown. In FIG. 4, alike reference numerals refer to alike structures as compared to FIG. 3. In this second embodiment, in addition to the housing 302 and support structure 404, the sensor cavity 306 is defined by an upper housing 450. Here, the support structure 404 is altered to provide a larger undercut region 440 such that a backside surface 442 of the support structure 404 resides further within the sensor cavity 306 as compared to the first embodiment 300 of FIG. 3.

The upper housing 450 spans the diameter of an opening (opposite the inlet 308) formed by the housing 302 and is attached in airtight fashion to a terminal edge of the housing 302 using known techniques. An opening is centrally formed in the upper housing 450 such that the support structure 404 may be attached in airtight fashion to the upper housing 450 using known techniques. The upper housing 450 further comprises a flange 452 that extends into the undercut region 440 opposite the backside surface 442 of the support structure 404. An annular portion 454 of the flange 452 extends downward (as depicted in FIG. 4) and a radially extending portion 456 of the flange 452 extends substantially parallel to the diaphragm plane 316 such that a peripheral edge of the radially extending portion 456 has a diameter that is larger than an outermost diameter of the support structure 404 but less than an inner diameter of the housing 302. In this manner, the flange 452 establishes a third horizontal flow path 460 and further establishes a fourth horizontal flow path 462 in cooperation with the backside surface 442 of the support structure 404.

Furthermore, the flange 452 has at least one aperture 434 formed therein providing fluid communication between the third and fourth horizontal flow paths 460, 462. In the illustrated embodiment, the at least one aperture 434 is formed in the annular portion 454 of the flange 452. However, this is not a requirement as the at least one aperture 434 may instead be formed in the radially extending portion 456 of the flange 452.

In this embodiment, the contamination shield 420 once again has a cup-like shape and comprises a lower wall 422 disposed on a second side of the diaphragm plane 316 and a lateral wall 424 extending there from to the first side of the diaphragm plane 316. Unlike the first embodiment of FIG. 3, the lateral wall 424 does not have apertures formed therein. Additionally, the contamination shield 420 is mounted on the radially extending portion 456 of the flange 452. In this manner, the radially extending portion 456 effectively serves as an upper wall of the contamination shield.

Thus configured, the at least one fluid communication path established includes (in order proceeding from the inlet 308 to the diaphragm 312) the first horizontal flow path 326, the first vertical flow path 328, the third horizontal flow path 460, the at least one aperture 434, the fourth horizontal flow path 462, the second vertical flow path 330 and the second horizontal flow path 332. With the addition of the third and fourth horizontal flow paths 460, 462, the overall length of the at least one fluid communication path is substantially increased, thereby providing additional isolation of the capacitive structure 310 from the inlet 308, as well as even greater opportunities for particulates and condensates to accumulate before encountering the diaphragm 312.

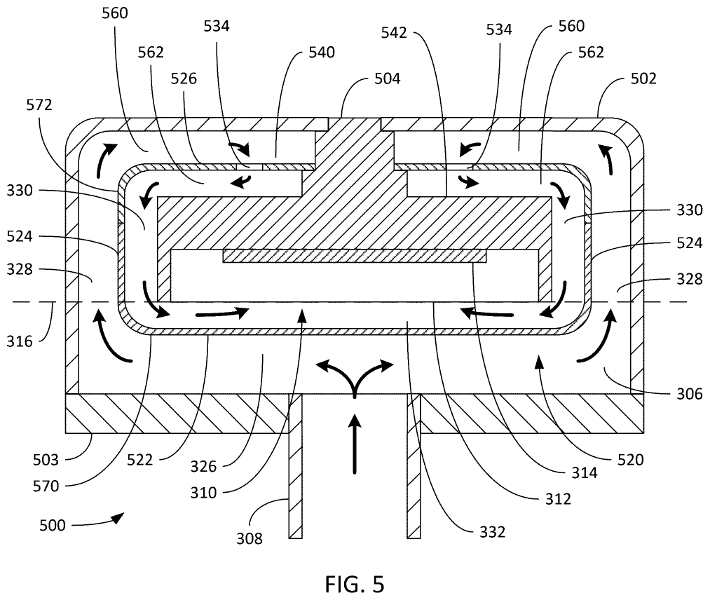

Referring now to FIG. 5, a simplified illustration of a third embodiment of a vacuum pressure sensor 500, comprising a contamination shield in accordance with the instant disclosure, is shown. In FIG. 5, alike reference numerals refer to alike structures as compared to FIG. 3. In this third embodiment, a housing 302 once again has a cup-like structure. However, in this case, the housing 302 inverted such that it is mounted on a housing base 503 that, in turn, has the inlet 308 mounted thereon. Thus, the sensor cavity 306 is defined by the housing base 503, housing 502 and a support structure 504 mounted on the housing 502 (in a central opening formed in the housing 502). Once again, the support structure 504 is altered (relative to FIG. 3) to provide a larger undercut region 540 such that a backside surface 542 of the support structure 504 resides further within the sensor cavity 306 as compared to the first embodiment 300 of FIG. 3.

In the third embodiment, the contamination shield 520 includes a lower wall 522 and a lateral wall 524 substantially similar to those described above relative to FIGS. 3 and 4. In this case, however, the contamination shield also comprises an upper wall 526 extending radially inward from the upper terminus of the lateral wall 524. The upper wall 526 includes a central opening configured to receive a portion of the support structure 504 such that the upper wall 526 is attached in airtight fashion to the support structure 504 using known techniques. The upper wall 526 also comprises at least one aperture 534.

As further shown in FIG. 5, the contamination shield 520 is formed from two sections, a lower shield section 570 and an upper shield section 572, which sections may be attached to each other in airtight fashion using known techniques. As shown, the upper shield section 572 provides the 526 and a portion of the lateral wall 524, while the lower shield section 570 provides another portion of the lateral wall 524 as well as the lower wall 522. However, it is understood that the upper and lower shield sections 570, 572 could be constructed so as to respectively provide different portions of the various walls 522, 524, 526 defining the contamination shield 520.

Regardless, such a sectioned construction of the contamination shield 520 makes assembly of the sensor 500 simpler in that the upper shield section 572 may be first attached to the support structure 504. Thereafter, the lower shield section 570 is attached to the upper shield section 572 such that the contamination shield 520 substantially surrounds the capacitive structure 310. Thereafter, the assembly comprising the support structure 504 and contamination shield 520 is mounted on the housing 502, which is subsequently attached to the housing base 503.

In the third embodiment of FIG. 5, similar to the embodiment of FIG. 4, the at least one fluid communication path includes (in order proceeding from the inlet 308 to the diaphragm 312) the first horizontal flow path 326, the first vertical flow path 328, a third horizontal flow path 560, the at least one aperture 534, a fourth horizontal flow path 562, the second vertical flow path 330 and the second horizontal flow path 332. With the addition of the third and fourth horizontal flow paths 560, 562, the overall length of the at least one fluid communication path is once again substantially increased, thereby providing additional isolation of the capacitive structure 310 from the inlet 308, as well as even greater opportunities for particulates and condensates to accumulate before encountering the diaphragm 312.

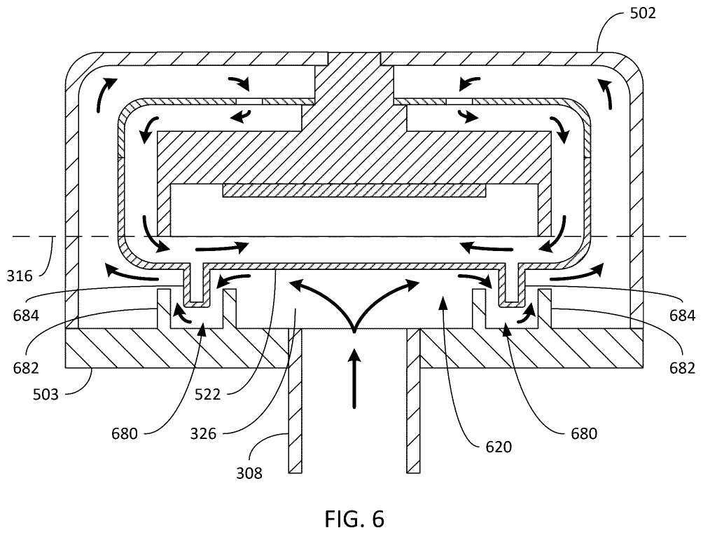

Referring now to FIG. 6, a fourth embodiment of a vacuum pressure sensor 600, substantially similar to the third embodiment of FIG. 6, is shown. However, in this fourth embodiment, partial obstructions in the form of labyrinth features 680 disposed within the first horizontal flow path 326. Although depicted within the first horizontal flow path 326, it is appreciated that such labyrinth features 680 may be alternatively, or additionally, disposed in any of the other horizontal or vertical flow paths described in any of the presently disclosed embodiments. In the illustrated example, each of the labyrinth features 680 comprise a pair of upwardly extending protuberances 682 formed in the housing base 503 and a downwardly extending protuberance 684 formed in the lower wall 522 of the contamination shield 620 and interdigitated between the upward extending protuberances 682. Formed in this manner, the labyrinth features 680 once again add to the overall distance of the at least one fluid communication path and provide additional surface area for the capture of contaminants. It is noted that, although a form of the labyrinth features 680 comprising a single interdigitation is shown, this is not a requirement in that each of the labyrinth features 680 may comprise multiple interdigitations, e.g., three upwardly extending protuberances 682 with two downwardly extending protuberances 684 interdigitated therebetween. As yet another alternative, each of the labyrinth features 680 may be more simply constructed in that they comprise only a single upwardly or downwardly extending protuberance 682, 684.

While the various embodiments in accordance with the instant disclosure have been described in conjunction with specific implementations thereof, it is evident that many alternatives, modifications and variations will be apparent to those skilled in the art. For example, the various housing embodiments illustrated in FIGS. 3-6 may be interchanged where possible. Accordingly, the preferred embodiments of the invention as set forth herein are intended to be illustrative only and not limiting so long as the variations thereof come within the scope of the appended claims and their equivalents.

What is claimed is:

1. A vacuum pressure sensor comprising an electrode and a diaphragm forming a capacitive structure, the sensor comprising:
a housing defining a sensor cavity and comprising a support structure configured to support the capacitive structure within the sensor cavity such that the diaphragm resides in a diaphragm plane and the electrode extends substantially parallel to the diaphragm on a first side of the diaphragm plane, the housing further comprising an inlet disposed on a second side of the diaphragm plane and configured to be in fluid communication with a measured environment; and
a contamination shield, disposed in the sensor cavity between the inlet and the capacitive structure, wherein the contamination shield is configured to provide at least one fluid communication path from the inlet to the diaphragm, wherein each of the at least one fluid communication path crosses the diaphragm plane at least twice.

2. The vacuum pressure sensor of claim 1, wherein the housing and contamination shield are formed from corrosion resistant material.

3. The vacuum pressure sensor of claim 2, wherein the contamination shield comprises INCONEL or 316L stainless steel.

4. The vacuum pressure sensor of claim 1, wherein the contamination shield is mounted on the support structure.

5. The vacuum pressure sensor of claim 1, wherein each of the at least one fluid communication path is provided in part by an aperture formed in the contamination shield on the first side of the diaphragm plane.

6. The vacuum pressure sensor of claim 1, wherein the contamination shield comprises a lower wall extending substantially parallel to, and on the second side of, the diaphragm plane, and further comprises a lateral wall extending from the lower wall such that a distal edge of the lateral wall terminates on the first side of the diaphragm plane.

7. The vacuum pressure sensor of claim 1, wherein the support structure comprises an undercut region extending substantially parallel to, and on the first side of, the diaphragm plane to define a backside surface of the capacitive structure.

8. The vacuum pressure sensor of claim 7, wherein the contamination shield comprises a lower wall extending substantially parallel to, and on the second side of, the diaphragm plane, a lateral wall extending from the lower wall to the first side of the diaphragm plane and an upper wall extending from the lateral wall substantially parallel to the diaphragm plane,
wherein the upper wall is disposed between the housing and the backside surface of the support structure, and
wherein the upper wall comprises at least one aperture defining the at least one fluid communication path.

9. The vacuum pressure sensor of claim 8, wherein the contamination sensor is formed from an upper shield section and a lower shield section.

10. The vacuum pressure sensor of claim 9, wherein the upper shield section is provided as a portion of the support structure.

11. The vacuum pressure sensor of claim 9, wherein the upper shield section comprises the upper wall.

12. The vacuum pressure sensor of claim 11, wherein the upper shield section comprises at least a portion of the lateral wall.

13. The vacuum pressure sensor of claim 1, wherein a fluid communication path of the at least one fluid communication path comprises at least one labyrinth feature partially obstructing the fluid communication path.

14. The vacuum pressure sensor of claim 13, wherein the at least one labyrinth feature is disposed on the housing.

15. The vacuum pressure sensor of claim 13, wherein the at least one labyrinth feature is disposed on the contamination shield.
